(19) United States
(12) Patent Application Publication
(10) Pub. No.: US 2015/0332259 A1
(43) Pub. Date: Nov. 19, 2015

(54) SECURE PAYMENT SYSTEM AND METHOD

(71) Applicant: Clear Token Inc., Denver, CO (US)

(72) Inventor: Stanley J. Wolfson, Denver, CO (US)

(21) Appl. No.: 14/709,001

(22) Filed: May 11, 2015

Related U.S. Application Data
(60) Provisional application No. 61/992,260, filed on May 13, 2014.

(51) Int. Cl. G06Q 20/38; G06Q 20/40; G06Q 20/36

(52) U.S. Cl. CPC G06Q 20/382; G06Q 20/367; G06Q 20/40

(57) ABSTRACT

A secure payment system and method are disclosed. An example secure payment system includes a vending device configured to receive a token from the customer for a transaction at the vending device. The vending device is further configured to confirm validity of the token based on a transaction index and a transaction code of the token. In response to a valid token, the vending device is configured to negotiate the transaction for the customer. In an example, the system also includes a remote payment processor to confirm payment by the customer for the transaction and issue the token to the customer, the token having the transaction index and the transaction code.

### RELATED APPLICATIONS

This application claims the priority benefit of U.S. Provisional Patent Application No. 61/992,260 titled “Secure payment system” of Stanley J. Wolfson, filed on May 13, 2014, and is also related to U.S. Provisional Patent Application No. 61/951,875 titled “Secure payment system” of Stanley J. Wolfson, filed on Mar. 12, 2014 and corresponding U.S. patent application Ser. No. 14/645,196 filed on Mar. 11, 2015, and U.S. patent application Ser. No. 14/671,456 titled “Parking Meter Payment Device” of Berman, et al. filed on Mar. 27, 2015, each of which is hereby incorporated by reference for all that is disclosed as though fully set forth herein.

### BACKGROUND

Increasingly, our global society is moving towards a culture in which transactions, whether social or business in nature, take place electronically via wireless devices including for example, mobile phones, tablets, computers and other electronic devices through connection to the Internet or wireless provider network (e.g., 3G, 4G networks). While these transactions can be easily implemented in an online environment, and even in a physical store environment by having a store clerk available to assist customers and/or reduce the occurrence of fraud (e.g., data processing and so-called “skimming” of credit card information), some purchases may lack such a facilitator, for example at a parking meter or vending machine. These purchases often require the buyer to have dollar bills or change available. Although credit card payment systems may be provided, these may be subject to fraud and identity theft.

### BRIEF DESCRIPTION OF THE DRAWINGS

FIG. 1 is a block diagram of an example secure payment system.

FIG. 2A is a high-level diagram of a vendor processor of the secure payment system.

FIG. 2B is a high-level diagram of a vending device of the secure payment system.

FIG. 3 illustrates example communication and commands which may be implemented by the secure payment system.

FIG. 4 illustrates an example coding scheme to build a token at a vendor processor.

FIG. 5 illustrates an example coding scheme to validate a token and process a transaction at a vending device.

FIG. 6 is a flow chart illustrating example operations which may implement a secure payment method.

FIG. 7 is a flow chart illustrating example operations of a vendor processor to implement a secure payment method.

FIG. 8 is a flow chart illustrating example operations of a vending device to implement a secure payment method.

### DETAILED DESCRIPTION

A secure payment system is disclosed which may be implemented to pay for products and/or services using an electronic device such as, but not limited to, a mobile phone, without needing to have a physical credit card or traditional cash on hand. In an example, a user (e.g., a customer) may issue a request for a transaction at a vending device (e.g., a parking meter or vending machine). The request is processed to confirm payment, and a token (e.g., a secure digital certificate such as an electronic data file) is issued to the customer.

The customer may then transmit (e.g., wirelessly transmit) the token to the vending device, whereupon the vending device validates the token and negotiates the transaction (e.g., adds time to a parking meter or dispenses products from a vending machine).

An example vending device of the secure payment system includes a wireless certificate reader configured to receive a digital certificate or “token” from a mobile computing device. In use, a mobile computing device (e.g., mobile phone) may include an installed application or “app”. When the mobile computing device is activated via the app, it searches for any vending devices in the area which may be operated with the digital payment and vending system. In an example, the app may display a list of such devices (e.g., parking meters in the user's vicinity) which accept payment via the secure payment system. In other examples, the customer may manually identify the vending device (e.g., by entering a device ID in the app).

It is noted that the wireless certificate reader does not need to establish a connection to the payment provider or other entity. As such, the vending device does not need to be configured with an expensive to install and maintain modem or other communications system. The wireless certificate reader can instead be a BLUETOOTH™ or other near-field communication protocol for communicating with the mobile computing device in proximity to the vending device.

In an example, data to validate the token received at the vending device is stored in the local memory of the vending device before a transaction is initiated at the vending device. As such, no communication connection is required between the digital payment and vending system and the third party payment system. This enables use of the digital payment and vending system without having to provide expensive communication connections in each vending device.

The token may be a one-time-use digital certificate. In an example, after the token has been confirmed and the transaction negotiated, the corresponding information stored in the vending device may be “wiped” clean (e.g., the code set to zero or otherwise erased). This helps ensure that the goods and/or services delivered by the vending device have been paid for and that the same digital certificate is not being re-used. In another example, the token may include an expiration, so that a customer cannot purchase tokens in advance to avoid price increases.

It is noted that the secure payment system has a wide variety of applications, such as but not limited to parking meters, point of sale transactions, voucher printers, access control (e.g., to a parking garage), vending machines, access control (e.g., to gated communities), and car washes, to name only a few examples.

By way of further illustration, the secure payment system may also be implemented for, but is not limited to, the service of authorizing use of a product or access to a location, such as with rental cars (or any other rental, such as bikes, boats, etc.), lodging (e.g., hotel rooms), transportation (e.g., bus, taxi, or train), admission to a ball park or amusement park or museum or other attraction, and any other pay-for-use of goods and/or services. For example, the secure payment system may provide a lock combination or other code to the user so that a cable lock or the like may be unlocked to access a bicycle, scooter, or motorcycle. In an example, a combination code can be provided to a lock box which opens to provide the user with a key (e.g., for a car or house). In another example, the lock may automatically actuate to unlock upon receiving payment confirmation.

Still other applications may include, but are not limited to point of sale transactions, vouchers, access control, etc. Still other implementations may also be used to make a donation (e.g., wherein nothing is physically delivered to the end user), such as to take the place of a donation box.

Of course, the secure payment system may be implemented with any vending device. The examples described herein are merely illustrative, and other applications will also become apparent to those having ordinary skill in the art after becoming familiar with the teachings herein.

In an example, the secure payment system may operate with a third-party payment processor to handle payments for the user without the user having to provide any credit card or other form of payment (or personal or other information) to the secure payment system. For example, the user may have already provided payment information (e.g., credit card or bank account information) to the third-party payment processor, who is a trusted payment processor such as the user's hank, credit card issuer, direct carrier billing (e.g., billing to a cell phone account), digital currency, or other payment service, and therefore the user does not have to provide any payment information to the vending device (or anyone associated with the vending device). As such, the secure payment system reduces the occurrence for fraud, while providing the user with convenience of a so-called “cashless” transaction. Likewise, the owner of the vending device receives payment from a trusted third-party payment processor without risk that the payment form (e.g., credit card) is stolen or unauthorized.

It is noted that the systems and methods described herein are not limited to any particular type of vending device, mobile device, and/or payment processor. The digital payment and vending system may be used in an attended and/or unattended environment, and may be used to deliver any type and/or quantity of goods and/or services, whether or not those are for actual physical goods.

Before continuing, it is noted that as used herein, the terms “includes” and “including” mean, but is not limited to, “includes” or “including” and “includes at least” or “including at least.” The term “based on” means “based on” and “based at least in part on.”

The term “vendor” is used herein to refer to a provider of goods and/or services. The vendor may be the owner or operator or otherwise associated with a vending device (or devices). In an example, the vendor is the owner of a business or the business itself which operates the vending device. The vendor may also be an entity, such as a government entity. The vendor may also be a combination of individuals and/or entities. For example, the vendor may be the city government and/or a contractor hired to operate the vending device(s) such as a parking meter (or meters). In another example, the term vendor may refer to one or more of a single contractor which operates parking meters for multiple different cities (and their associated city governments). It is noted that the term “vending device” is used to designate a single device or may include multiple devices operatively associated with each other to carry out the operations disclosed herein.

The term “token” as it refers to a type of “digital certificate” (or “electronic information” or “data packet”) is intended to broadly designate data or information provided by the system to a mobile device, which may or may not be further processed by the mobile device, and which is capable of being processed in conjunction with data or information provided at the vending device to verify or otherwise confirm payment.

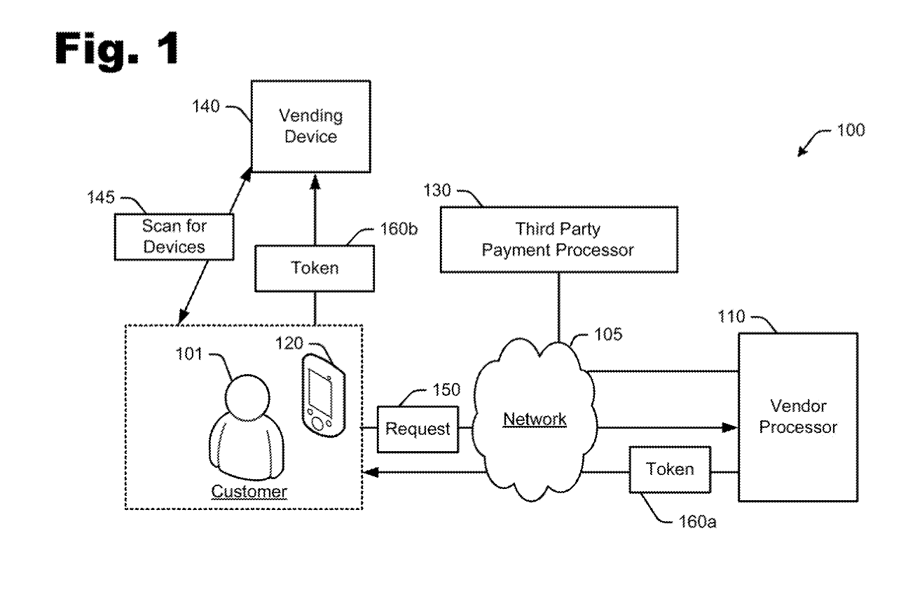

FIG. 1 is a block diagram of an example secure payment system 100. System 100 may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other logic described herein.

In an example, the secure payment system 100 may be implemented by a vendor processor 110 providing a digital payment and vending service accessed by a user 101 via a client device 120 (referred to herein collectively as the “customer”). The client device 120 may be any suitable computer or computing device (e.g., laptop computer or other mobile device such as a phone or tablet) capable of accessing a third party payment processor 130.

Of course, the vendor processor 110 and client device 120 are not limited to any particular type of devices (e.g., watches and other wearable technology), and may also include other devices that are traditionally not considered to be a part of the mobile environment (e.g., desktop computing devices or terminals).

In an example, the secure payment system 100 may be implemented with one or more communication network 105, such as a local area network (LAN) and/or wide area network (WAN) and/or other communications platform such as a mobile communications network. In an example, the network includes the Internet and/or other mobile communications network (e.g., a 3G or 4G mobile device network).

In an example, the secure payment system 100 provides a way for the user 101 to pay for a product and/or service offered by a vendor at a vending device 140, using the user's own mobile device 120, via the digital payment service implemented by the vendor processor 110, but without having to provide the vending device 140 (or any other party such as the vendor or vendor processor) with access to payment information maintained by third party payment processor(s) 130 (e.g., a bank or credit card company).

In use, a mobile device 120 (e.g., a mobile phone) may include an installed application or “app”. When the mobile device 120 is activated via the app, the mobile device 120 searches 145 for any vending devices 140 in the area which are configured for operation in the environment of the secure payment system 100. In an example, the app may display a list of such device(s) 140 (e.g., parking meters in the user's vicinity) on the mobile device 120 which accept payment via the payment technique described herein.

In an example, the user may issue a request 150 to the vendor processor 110. The request 150 may include the vending device ID (e.g., a number shown on the vending machine) or other identifying information. The request 150 may also include other information about the intended purchase (e.g., parking time, product ID) and a payment authorization. For example, the amount of payment may be displayed for the user by the app for the user to accept or approve the item and amount. The user may then select a third party payment processor 130 (e.g., a bank, credit card, or mobile phone service carrier) from the app. This information may be transmitted in the request 150 to the vendor processor.

The vendor processor 110 then confirms payment via the third party payment processor 130. For example, the vendor processor 110 may issue a payment authorization to a third-party payment processor 130, and receive payment approval from the third-party payment processor. After confirming payment, the vendor processor 110 may generate a token 160a and issue the token 160 to the user's mobile device 120.

After receiving the token 160a, the user may then complete the transaction at the vending device 140. In an example, the vending device 140 includes a wireless certificate reader configured to receive a token 160b from the mobile device 120. The token 160a and 160b may be the same token provided by the vendor processor 110, or token 160b may undergo at least some degree of processing at the mobile device 120 before being issued to the vending device 140.

The vending device 140 may then process the token 160b to confirm payment by the user 101. If payment is confirmed, then the vending device 140 may negotiate the transaction (e.g., validate parking or dispense an item from the vending device 140).

As such, the system 100 provides a way for the user 101 to pay for a product or service (e.g., parking) offered by a vending device 140, using the user's own mobile device 120, but without having to provide the vendor with access to payment details maintained by third party payment processor(s) 150 (e.g., a bank or credit card company).

In an example, various operations of the secure payment system 100 may be implemented at least in part by program code and/or logic circuitry. Program code and/or logic used to implement features of the system can be better understood with reference to the following discussion and corresponding figures of various example functions. To the extent program code is implemented, machine-readable instructions may be stored on a non-transient computer readable medium and are executable by one or more processor to perform the operations described herein. Examples of program code may include an end-user mobile device application (or “app”), payment processing application(s), host application (e.g., for generating the token in response to receiving confirmation of payment), and/or a vendor application (e.g., for validating the token received from the end-user device). Of course, the operations described herein are not limited to any specific implementation with any particular type of program code or logic.

It is noted, however, that the secure payment system 100 is not strictly program code in the traditional sense. That is, the secure payment system 100 may be implemented at least in part in program code (e.g., for generating the token and for various of the transmission protocols). It is to be understood that the secure payment system 100 is also implemented by device hardware which goes beyond a mere computing device provided to execute the program code. Example device hardware may include a wireless certificate reader with a communications interface (e.g., to the mobile device). Example device hardware may also include a vending device with associated electronic actuators, locks, motors, conveyors, timers, and/or other electronics operable to deliver goods and/or services in response to input from the wireless certificate reader and/or other processing device confirming payment for the goods and/or services.

These and other aspects of the secure payment system 100 will be described in more detail below such that the device hardware can be readily implemented by one having ordinary skill in the art after becoming familiar with the teachings herein.

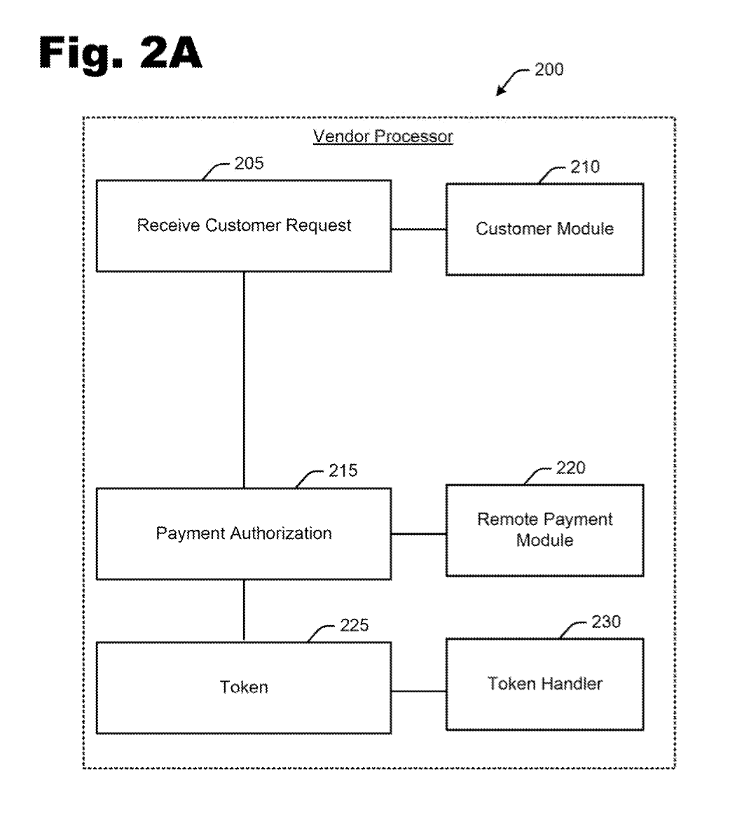

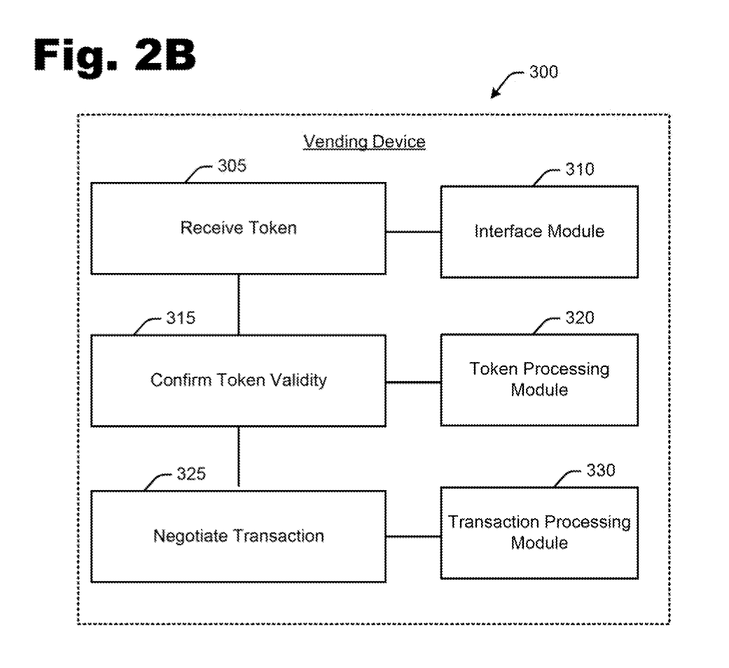

FIG. 2A is a high-level diagram of a vendor processor 200 (e.g., vendor processor 110 in FIG. 1) of the secure payment system. The vendor processor 200 may receive a request 205 for a transaction (e.g., including a payment amount) at a vending device via a customer module 210. In an example, the request 205 may include information about the vending device (e.g., identifying information for the vending device). The vendor processor 200 issues a payment authorization 215 via a remote payment module 220 to a third-party payment processor. It is noted that the vendor processor does not actually receive any payment or other personal or confidential payment information from the customer. This information remains confidential as between the customer and the third party payment processor (e.g., the customer's bank or credit card processor). The vendor processor 200 receives payment approval from the third-party payment processor. The vendor processor 200 includes a token handler 230 to generate a token 225 and issues the token 225 to the customer so that the customer can complete the transaction at the vending device.

FIG. 2B is a high-level diagram of a vending device 300 (e.g., vending device 140 in FIG. 1) of the secure payment system. The vending device 300 receives a token 305 from the customer (e.g., the token 225 issued to the customer by the vendor processor 200 in FIG. 2A) via an interface module 310. In an example, vending device 300 may receive the token 305 from the customer's mobile device via a BLUETOOTH™ or other near-field communication protocol. A token processing module 320 at the vending device 300 compares data value(s) of the token 305 to data value(s) stored at the vending device 300. For example, the vending device may translate the hex value to determine the transaction code and the transaction index, and then compare these to the corresponding device code stored at the associated index location at the vending device.

The vending device 300 confirms that the token is valid at 315. If the token is valid, a transaction processing module 330 at the vending device 300 may negotiate the transaction 325. In an example where the vending device is a parking meter, the transaction processing module 330 may set (or add) a time duration for the customer to park in a designated parking space. In an example where the vending device is a vending machine, the transaction processing module 330 may operate the mechanics to dispense the purchased product. Other examples are also contemplated, e.g., wherein the vending device is a point-of-sale device, point-of-entry, or other type of device.

It is noted that the term “module” as used herein means electronic devices (e.g., logic circuitry) and/or machine readable instructions (e.g., firmware) specifically configured to carry out the operations described herein.

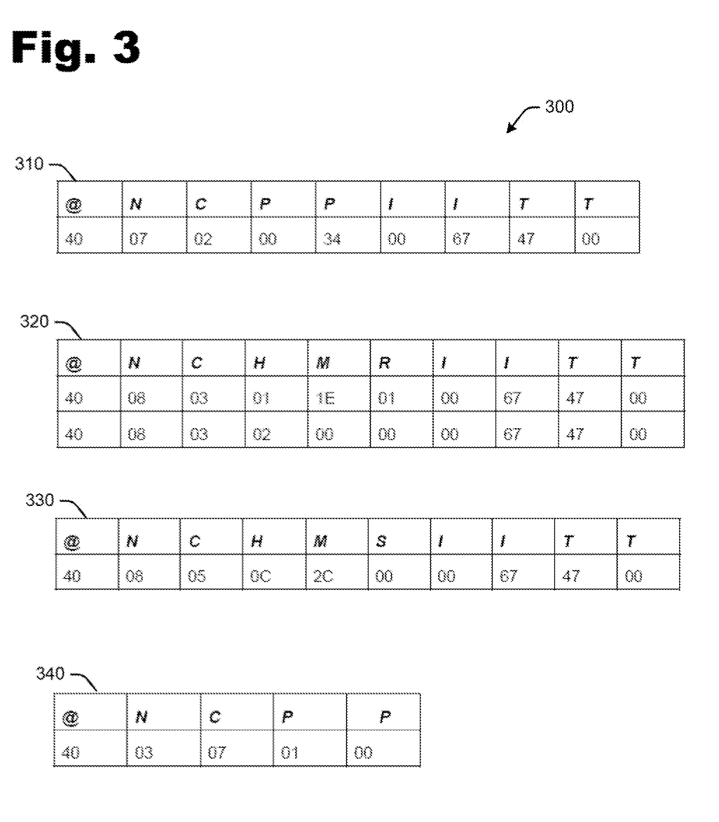

FIG. 3 illustrates example communication and commands 300 which may be implemented by the secure payment system. In an example, the commands and data are in arrays of bytes, with values from 0x00 to 0xFF. The number of bytes sent or received through the FIFO handle is 20 or less at a time. All commands to the CTD begin with a 0x40 (@). The next byte in the array is the number of remaining bytes in the command. In an example, the general format of a command is @N C P P I I T T, where.
@=0x40
N Number of bytes to follow
C=Command code (1 byte)
P=Parameters for the command (number of bytes varies with each command) I=Index of the validating token (2 bytes, most significant first)
T=validating token (2 bytes, most significant first)

It is noted that the value T having 2 bytes can account for about 65,000 unique codes. Of course, other byte values may also be used. For example, a 3 byte code allows for 65K times 255, or about 16 million unique codes. A 4 byte code allows for about 4 billion unique codes.

In an example, the secure payment system uses a custom serial data service for commands. The custom serial data service is represented by a UUID of 6x2456e1b926e28f83e744f34f01e9d701. When the handle for that UUID is found, a “characteristic discover” is performed. This returns two more UUIDs and handles, for example:
0x2456e1b926e28f83e744f4f01e9d70 (serial data FIFO characteristic); and
0x2456e1b926e28f83e744f34f0e9d704 (serial data Credits characteristic).

In an example, the hardware may support flow control which is related to the credits characteristic. The next step is to run a “descriptor discover” on the FIFO characteristic. This returns another handle and a short 0x2902 UUID, which is a Client Characteristic Configuration. A 0x01 (or 0x0100) is written to this handle. This sets up “notification” on the FIFO characteristic. Also, this is the final step in setting up a connection with the secure payment system. This “wakes up” the hardware for the secure payment system and the antenna symbol appears on the LCD. Another example is to set this up for “indication”.

Commands and data can now be exchanged with the secure payment system (covered in more detail in the next section). Commands are sent to the secure payment system by writing up to 20 bytes to the FIFO characteristic handle. Data is received back through the same handle with notification.

After communication, the connection is disconnected (e.g., an antenna symbol disappears from the LCD), and the secure payment system finishes carrying out any tasks, then goes back to sleep. This minimizes connection time to the CTD device to conserve battery power.

To make the process even more secure, the code can be sent from the user's mobile device as a two part message, wherein part one is a gatekeeper command or message including a unique code and informing the vending device that part two is following, and then another unique code is sent as part two as an activating command or message. This technique implements two codes for each transaction.

In this example, all replies from the CTD begin with a 0x52. The next byte in the array is the remaining number of bytes in the reply. In an example, the general format of a reply is: R N S, where:
R=0x52
N=number of bytes to follow
S=status (0x01 if command was successful or 0x00 if there was an error)

Validating tokens may also be implemented with the commands. For example, there may be 65536 index positions (0-65535), with each index containing a token with a value from 1-65535. Once a token is used, it is zeroed to prevent re-use and thus reduce fraud.

If an incorrect index/token combination is received, the device responds with a status of 0x00, and not respond to further commands until some time has passed.

An example Query Command (not shown) verifies communication. It returns a Status of 0x01. Command: @ N C, where:
@=0x40
N=0x01, number of bytes to follow
C=0x01
Reply: R N S R=0x52
N=0x01, number of bytes to follow
S=0x01

In the drawings, the following abbreviations are used:
=9x40—Start of the command
N=Number of bytes to follow
C=Command Code
P=Time (used in Closure & Backlight)
I=Index. Value
T=Token Value
H=Hours
M=Minutes
S=Seconds
R=Reset (00=No Reset−01=Reset)

Command 310 is an example Contact Closure Command. This command closes the relay contact for the specified length of time. The length of time the contact remain closed is the number of 3.90625 millisecond units ( 1/256 of a second) specified with 2 bytes. For example, to close the contact for 1 second, a value of 0x0100 is used; to close the contact for a half second, a value of 0x0080 is used. A value of less than 0x0034 (200 mS) should not be used for this example. @N C P P I I T T, where.
@=0x40
N=047, number of bytes to follow
C=0x02
P=length of time for contact closure, MSB first, range 0x0034−0xFFFF I=index of validating token. MSB first
T=validating token, MSB first

Reply: R N S R=0x52, where:
N=0x01, number of bytes to follow
S=0x01 if command and token were successful, 0x00 if index/token was not valid or some other error.

Command 320 is an example Add Time Command. The first command (illustrated by row 1) puts a time of 1:30 on a parking meter and then resets to 0. The second command (illustrated by row 2) adds 2:00 without a reset.

The Add Time Command adds time to a countdown timer used in such applications as a parking meter. There are three parameters. The first two parameters are hour and minutes. The third parameter is a reset flag. If the reset flag is 0x01, any time already existing on the meter will be cleared. If the reset flag 0x00, the additional time may be added to the existing time and a new total determined. This can be used, for example, if the same customer is identified. @ N C H M R I I T T, where:
@=0x40
N=048, number of bytes to follow
C=0x03
H=hours
M=minutes
R=reset flag: 0x01 resets any existing time, 0x00 adds to any existing time
I=index of validating token, MSB first
T=validating token, MSB first

Reply: R N S R=0x52
N=0x01
S=0x01 if command and token were successful, 0x00 if index/token was not valid or some other error.

An example Time Status Command (not shown) returns the status of whether the countdown timer is zero. Can be used for enforcement. @ N C where:
@=0x40
N=0x01 number of bytes to follow
C=0x04

Reply: R N S R=0x52
N=0x01
S=0x01 if time still remains on countdown timer. 0x00 if countdown timer has reached zero.

Command 330 is an example Set Time Command. This command sets the time to 12:44:00 (0C 2C 00). This command sets the current time of day, which is displayed in the upper right of the LCD display, @N C H M S I I T T, where:
@=0x40
N=0x08, number of bytes to follow
C=0x05
H=hours (0-23)
M=minutes (0-59) S=seconds (0-59)
I=index of validating token, MSB first
T=validating token, MSB first

Reply: R N S R=0x52
N=0x01
S=0x01 if command and token were successful, 0x00 if index/token was not valid or some other error.

An example Set Bluetooth Name Command (not shown) sets the Bluetooth name that is advertised by this device. N C A A A A . . . I I T T, where:
@=0x40
N=number of bytes to follow
C=0x06
A=ASCII characters (8-bit) (up to 13)
I=index of validating token, MSB first
T=validating token, MSB first

Reply: R N S R=0x52
N=0x01
S=0x01 if command and token were successful, 0x00 if index/token was not valid or some other error.

Command 340 is an LCD Backlight Command. This command sets the backlight on the parking meter for 1 second (e.g., so that the user can see the parking meter display).

The LCD Backlight Command turns on the LCD backlight for the specified length of time. The length of time the backlight remains on is the number of 3.90625 millisecond units ( 1/256 of a second) specified with 2 bytes. For example, to turn on the backlight for 1 second, a value of 0x0100 is used to turn on the backlight for 30 seconds, a value of 0x1E00 is used. No validating token is used with this command (should be reassessed at a later time). @ N C P P, where:
@=0x40
N=0x03, number of bytes to follow
C=0x07
P=length of time for backlight to be on, MSB first, range 0x0000-0xFFFF

Reply: R N S R=0x52
N=0x01, number of bytes to follow
S=0x01 if command was successful, 0x00 if some other error.

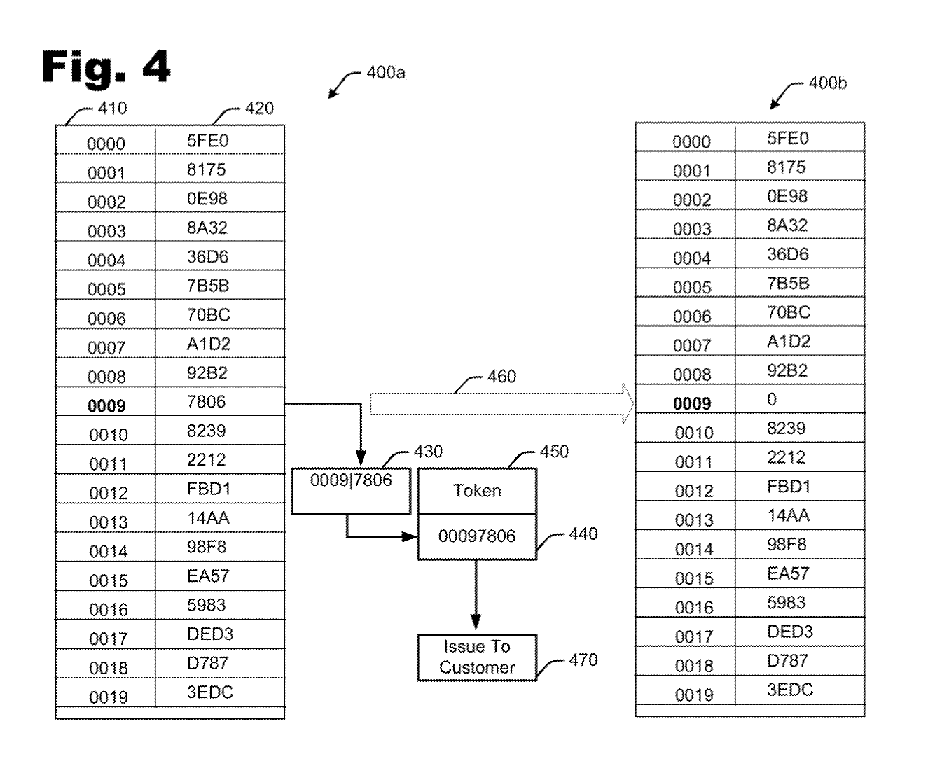

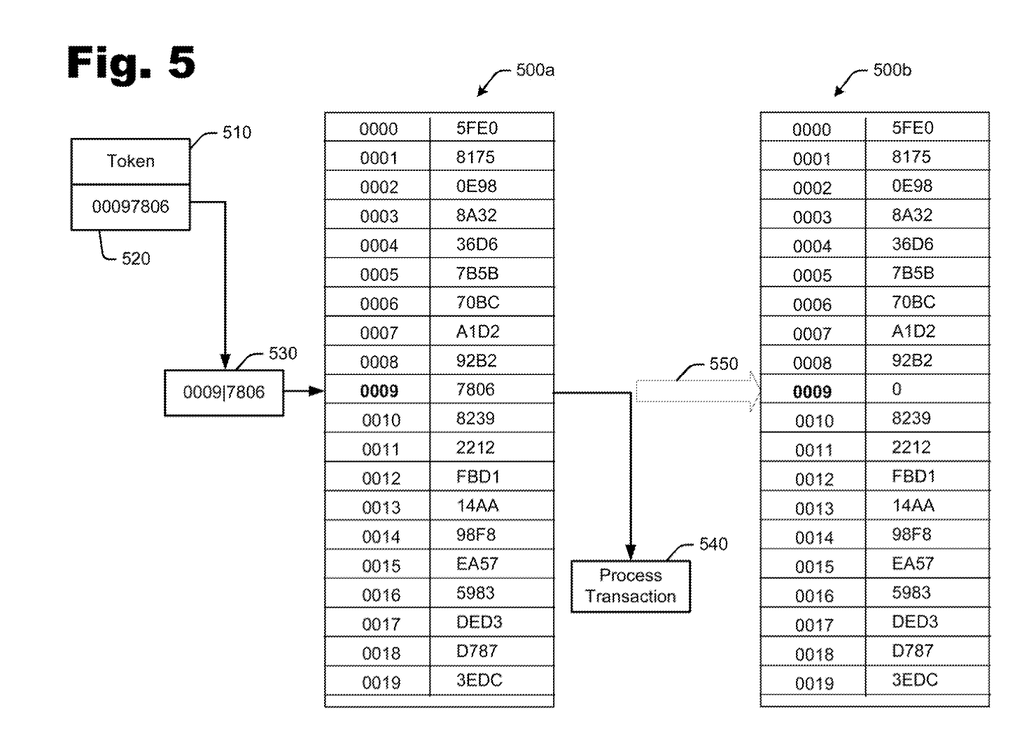

FIG. 4 illustrates an example coding scheme to build a token at a vendor processor. FIG. 5 illustrates an example coding scheme to validate the token illustrated in FIG. 4, and process a transaction at a vending device. The tables 400a-b in FIG. 4 and tables 500a-b in FIG. 5 illustrate a code sample (the first 20 entries of 65,536 entries are shown). The first column represents an index (1 through the number of entries), and the second column represents the corresponding code for the index entry. The codes shown in FIG. 4 may be stored at the vendor processor (e.g., vendor processor 110 shown in FIG. 1) and used to generate the token. These same codes (shown in FIG. 5) may also be written to the vending device (e.g., vending device 140 in FIG. 1) by ‘injecting’ the codes in hardware stored in or associated with the vending device. Each vending device includes its own set of unique codes in an indexed array, stored in memory internally at the vending device.

During set up, the vending device may be read (e.g., for device ID or location number, and a corresponding code). The codes may be compared to a database record stored by the vendor processor. If there is a match, then the vending device has been properly set up, and is ready for use by the customer.

During use, the user may open a phone app and select the location or other ID of the vending device. The location or other ID of the vending device may be transmitted by nearby mobile devices (e.g., using Bluetooth or other communications protocol), or the user may manually enter the location or other ID. A request is generated on the user's mobile device, including the location and/or other information (e.g., type of device such as a parking meter, vending machine, access gate, etc.). Additional information may also be included in the request, e.g., based on location type such as time for a parking meter, locker number for a locker, bill amount for bill changing. The user may also select a payment processor (e.g., a bank, credit card processor, PayPal®, etc.) to be included in the request. The user may be prompted to use the last payment processor used or enter a new payment processor.

The request is sent to the vendor processor to authorize payment. The payment processor may charge the user's account and return “Approved” or “Declined” to the vendor processor. The digital payment service may notify the user (e.g., if payment was declined). But the vendor processor never receives personal or financial information or credit card information of the user.

If the payment is approved, then the vendor processor may build a token for the user to deliver to the vending device. In an example, the token may include a location code, duration or activation code, security code (FIG. 4), and optionally an advertisement or other information for the user to view. For example, the vendor processor may select transaction index (e.g., index location 0009) from the index column 410 and read a corresponding transaction code (e.g., hex 7806 representing decimal 30726) from the code column 420, as illustrated by the numbers 430 in FIG. 4. It is noted that any suitable system (e.g., alpha-numeric) may be used, and is not limited to a numbering system.

In this example, the numbers are in hexadecimal and added (e.g., as packet 440) to the token 450. The table 400a may be updated as illustrated by arrow 460 and shown as updated table 400b, wherein the code at index location 0009 is set to “0”. The token 450 may then be issued to the customer as illustrated by block 460.

The user may then relay the token 510 including the hexadecimal 520 to the vending device, as illustrated in FIG. 5. The vending device receives the token, and validates the transaction code in the token (FIG. 5), for example by reading the token packet 520 and comparing the index and hex code 530 with the corresponding index location 0009 of the device index. If the device code at index location 0009 in table 500a matches the transaction code in the token 510, the vending device may negotiate or process the transaction 540 by executing a device command (e.g., activate a parking meter, activate an access device, vend a product, change a bill, etc.).

The vending device may also update/modify the table 500a stored at the vending device, as illustrated by arrow 550, to indicate that the code has been used (e.g., by setting the code in index 9 to all 0's) as shown by updated table 500b in FIG. 5. As such, the index location 9 cannot be re-used, thereby preventing fraudulent use.

In this example, a small 128K file contains 65,536 unique codes. For a parking meter application being used an average of 5 times every day, the original codes are predicted to last about 39 years. For an arcade game being use 20 times a day, the original codes are predicted to last about 9½ years. For a busy access control being accessed 100 times a day, the original codes are predicted to last about 2 years. In the event that the codes need to be changed or updated, a secure update procedure may be implemented to refresh the codes in the field.

It should be understood that the systems and techniques described above may be modified within the scope of the disclosure herein, and are not limited to any particular implementation. For example, the example code and indexing illustrated in the figures is illustrative and not limiting.

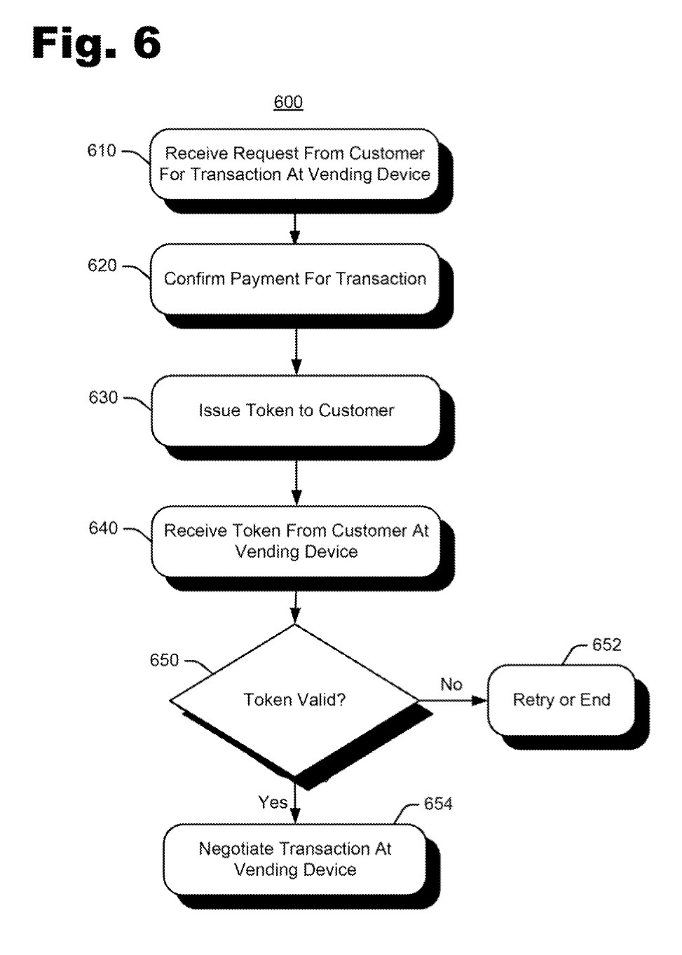

FIG. 6 is a flow chart illustrating example operations 600 which may implement a digital payment method. In example operation 610, a request for a transaction at a vending device may be received from a customer by a vendor processor. The vendor processor confirms payment for the transaction in operation 620, and then issues a token to the customer in operation 630. In an example, the token has a transaction index and a corresponding transaction code.

In operation 640, the token is received from the customer at a vending device. For example, the token may be received from the customer's mobile device via a BLUETOOTH™ or other near-field communication protocol with the vending device. In operation 650, the vending device confirms validity of the token, e.g., based on the transaction index and the transaction code. If the token is not valid, operations at the vending device may end with operation 652. In another example, the vending device may issue feedback to the user (e.g., to retry by sending a different token). If the token is valid, the vending device may negotiate the transaction at operation 654. In an example where the vending device is a parking meter, the vending device may set (or add) a time duration for the customer to park in a designated parking space. In an example where the vending device is a vending machine, the vending device may dispense the purchased product. Other examples are also contemplated wherein the vending device is a point-of-sale device, point-of-entry, or other type of device.

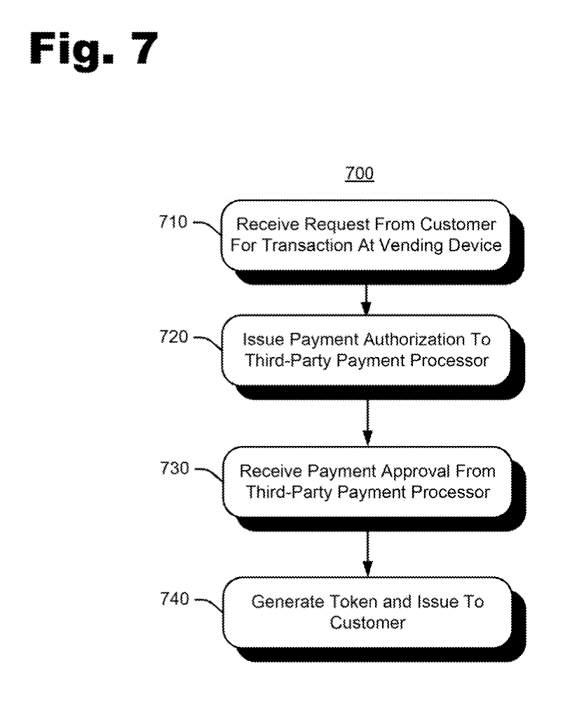

FIG. 7 is a flow chart illustrating example operations 700 of a vendor processor to implement a digital payment method. In operation 710, the vendor processor may receive a request for a transaction at a vending device from a customer. In an example, the request may include information about the vending device (e.g., identifying information for the vending device). In operation 720, the vendor processor issues a payment authorization to a third-party payment processor. It is noted that the vendor processor does not actually receive any payment or other personal or confidential payment information from the customer. This information remains confidential as between the customer and the third party payment processor (e.g., the customer's bank or credit card processor). In operation 730, the vendor processor receives payment approval from the third-party payment processor.

In operation 740, the vendor processor generates a token and issues the token to the customer so that the customer can complete the transaction at the vending device. In an example, the token includes a hex value representing the transaction code and the transaction index.

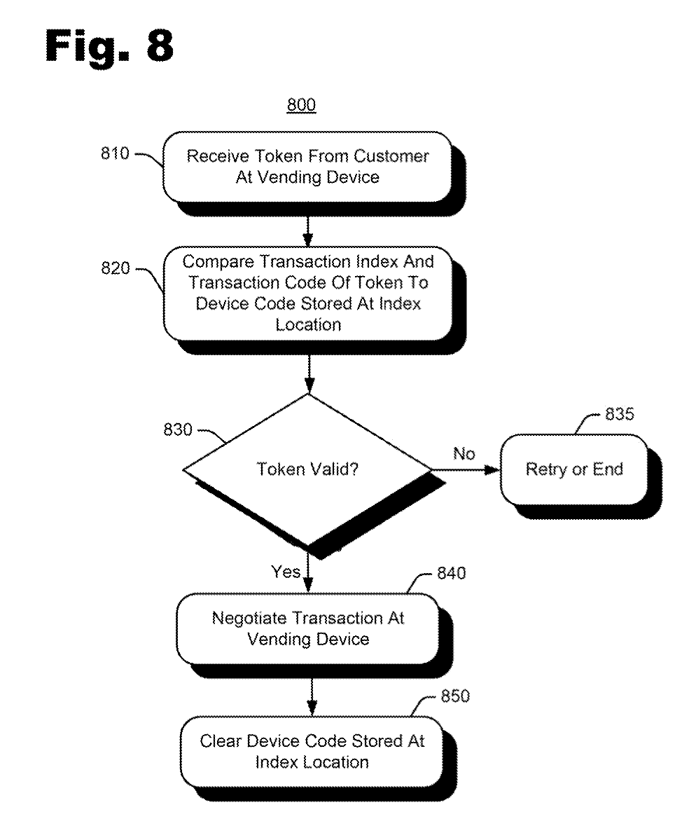

FIG. 8 is a flow chart illustrating example operations 800 of a vending device to implement a digital payment method. In operation 810, the vending device receives a token from the customer (e.g., the token issued to the customer by the vendor processor in operation 740). The vending device may receive the token from the customer's mobile device via a BLUETOOTH™ or other near-field communication protocol. In an example, the token includes a hex value representing the transaction code and the transaction index.

In operation 820, the vending device compares the transaction index and transaction code of the token to a device code stored at corresponding index location at the vending device. For example, the vending device may translate the hex value to determine the transaction code and the transaction index, and then compare these to the corresponding device code stored at the associated index location at the vending device.

In operation 830, the vending device determines whether the token is valid. If the token is not valid, operations at the vending device may end with operation 835. In another example, the vending device may issue feedback to the user (e.g., to retry by sending a different token).

If the token is valid, the vending device may negotiate the transaction at operation 840. In an example where the vending device is a parking meter, the vending device may set (or add) a time duration for the customer to park in a designated parking space. In an example where the vending device is a vending machine, the vending device may dispense the purchased product. Other examples are also contemplated wherein the vending device is a point-of-sale device, point-of-entry, or other type of device.

In operation 850, the vending device clears the device code stored at the index location so that the token cannot be reused.

Example operations shown in FIGS. 6-8 are illustrative and not intended to be limiting. The ordering of operations is not limited to the ordering shown in the drawings. Still other operations are also contemplated, as will become readily apparent to those having ordinary skill in the art after becoming familiar with the teachings herein.

It is noted that the examples shown and described herein are provided for purposes of illustration and are not intended to be limiting. Still other examples are also contemplated.

1. A digital payment method comprising:
receiving a request from a customer for a transaction at a vending device;
confirming payment by the customer for the transaction;
issuing a token to the customer for the transaction, the token having a transaction index and a transaction code;
receiving the token from the customer at the vending device;
confirming validity of the token at the vending device based on the transaction index and the transaction code; and
negotiating the transaction for the customer at the vending device.

2. The method of claim 1, further comprising retrieving identifying information for the vending device based on the request from the customer.

3. The method of claim 1, wherein confirming payment by the customer comprises:
issuing a payment authorization to a third-party payment processor; and
receiving payment approval from the third-party payment processor.

4. The method of claim 1, wherein confirming validity of the token at the vending device comprises comparing the transaction index and the transaction code of the token to a device code stored at an index location at the vending device.

5. The method of claim 4, further comprising clearing the device code at the index location at the vending device so that the token cannot be reused.

6. The method of claim 1, further comprising executing a device command at the vending device if the token is valid.

7. The method of claim 1, wherein the token includes a hex value representing the transaction code and the transaction index.

8. A secure payment system comprising a vending device configured to receive a token from the customer for a transaction at the vending device, the vending device further configured to confirm validity of the token based on a transaction index and a transaction code of the token, and in response to a valid token, the vending device configured to negotiate the transaction for the customer.

9. The system of claim 8 further comprising a remote payment module to confirm payment by the customer for the transaction and issue the token to the customer, the token having the transaction index and the transaction code.

10. The system of claim 9, wherein the remote payment module receives identifying information of the vending device from the request by the customer.

11. The system of claim 9, wherein the remote payment module confirms payment by:
issuing a payment authorization to a third-party payment processor; and
receiving payment approval from the third-party payment processor.

12. The system of claim 11, wherein the remote payment module confirms payment without receiving confidential payment information from the customer.

13. The system of claim 8, wherein the vending device confirms validity of the token by comparing the transaction index and the transaction code of the token to a device code corresponding to an index location stored at the vending device.

14. The system of claim 13, wherein the vending device clears the device code at the index location stored at the vending device so that the token cannot be reused.

15. The system of claim 14, wherein the device code stored at the vending device is refreshed via a secure field procedure.

16. The system of claim 8, wherein the token includes a hex value representing the transaction code and the transaction index.

17. A secure payment system comprising:
a remote payment processor to confirm payment by a customer for a transaction at a vending device and issue a token to the customer for the transaction, the token having a transaction index and a transaction code;
an interface module at a vending device configured to receive the token from the customer for the transaction;
a token processing module at the vending device to confirm validity of the token based on the transaction index and the transaction code of the token; and
a transaction processing module to negotiate the transaction for the customer at the vending device.

18. The system of claim 17, wherein the remote payment processor is configured to issue a payment request to a third-party payment processor, and receive payment approval from the third-party payment processor.

19. The system of claim 17, wherein the payment module of the vending device confirms validity of the token by comparing the transaction index and the transaction code of the token to a device code stored at an index location at the vending device.

20. The system of claim 17, wherein the payment module of the vending device clears the device code stored at the index location of the vending device after negotiating the transaction so that the token cannot be reused.
